(19) United States
(12) Patent Application Publication
(10) Pub. No.: US 2014/0253655 A1
(43) Pub. Date: Sep. 11, 2014

(54) IMAGE FORMING APPARATUS AND IMAGE FORMING METHOD

(71) Applicants: Noriyuki SAI, Kanagawa (JP); Kazuyoshi MATSUMOTO, Tokyo (JP)

(72) Inventors: Noriyuki SAI, Kanagawa (JP); Kazuyoshi MATSUMOTO, Tokyo (JP)

(73) Assignee: RICOH COMPANY, LTD., Tokyo (JP)

(21) Appl. No.: 14/184,892

(22) Filed: Feb. 20, 2014

(30) Foreign Application Priority Data
Mar. 8, 2013 (JP) 2013-046659

(51) Int. Cl. B41J 11/66

(52) U.S. Cl. CPC B41J 11/663
USPC 347/104

(57) ABSTRACT

An image forming apparatus and an image forming method are provided. The image forming apparatus includes a conveyer belt, a print head, a cutter, at least first and second rollers, and a controller. The conveyer belt conveys print media. The print head prints an image on the print media conveyed by the conveyer belt. The cutter is disposed downstream of the print head to cut the print media. The rollers are serially arranged between the print head and the cutter, and are configured to rotate the conveyer belt in the conveyance direction to convey the print media toward the cutter. The controller individually controls rotation speeds of the rollers to create a difference in rotation speed between the first and second rollers sufficient to make the print media bend between the first and second rollers while the cutter cuts.

### CROSS-REFERENCE TO RELATED APPLICATION

This patent application is based on and claims priority pursuant to 35 U.S.C. §119 to Japanese Patent Application No. 2013-046659, filed on Mar. 8, 2013, in the Japan Patent Office, the entire disclosure of which is hereby incorporated by reference herein.

### BACKGROUND

1. Technical Field

Example embodiments of the present invention generally relate to an image forming apparatus and image forming method capable of printing an image on a roll of paper.

2. Background Art

Label printers are known as a form of image forming apparatuses that print text or images on the surface of various kinds of labels such as point of purchase (POP) labels, price tags, and bar-code labels. Such labels are used for products on the market. Usually, such labels are adhesive labels backed with “release paper” (also called a “liner” or “separator”). In recent years, there is a trend toward using “linerless label paper” without “release paper (liner)” in order to save resources. Such linerless label paper is rolled like sticky tape, and an image forming apparatus (printer) that prints text or images on the linerless label paper is referred to as a linerless label printer.

Label printers are also known as printers that handle a roll of paper or other recording media in a similar manner to linerless label printers. In such label printers, a roll of labels is usually cut before text or images are to be printed thereon. This is because label printers can perform ordinary printing if the label is already cut before performing printing operation, which is practical and efficient. By contrast, it is desired that a label in a linerless label printer be cut on the downstream side of the conveyance path because it is difficult to peel off adhesive sheets. For this reason, a cutter is arranged on the downstream side of the conveyance path and a print head is arranged on the upstream side. Note that the sheet conveying process needs to be stopped when a roll label is to be cut, at least at a position where the roll label is cut, in both linerless label printer and label printer.

### SUMMARY

Disclosed embodiments provide an improved image forming apparatus and image forming method. The image forming apparatus includes a conveyer belt, a print head, a cutter, at least first and second rollers, and a controller. The conveyer belt conveys print media. The print head prints an image on the print media conveyed by the conveyer belt. The cutter is disposed downstream of the print head to cut the print media. The rollers are serially arranged between the print head and the cutter, and are configured to rotate the conveyer belt in the conveyance direction to convey the print media toward the cutter. The controller individually controls rotation speeds of the rollers to create a difference in rotation speed between the first and second rollers sufficient to make the print media bend between the first and second rollers while the cutter cuts.

The image forming method includes conveying, on a conveyer belt rotated by at least first and second rollers, print media on which an image is formed by a print head, cutting the print media with a cutter positioned downstream of the print head, and controlling speed of the conveying, by individually controlling rotation speeds of the rollers to create a difference in rotation speed between the first and second rollers sufficient to make the print media bend between the first and second rollers while the cutting is being performed.

### BRIEF DESCRIPTION OF THE DRAWINGS

A more complete appreciation of the disclosure and many of the attendant advantages and features thereof can be readily obtained and understood from the following detailed description with reference to the accompanying drawings.

FIG. 1 is a schematic diagram illustrating a basic configuration of a label printer.

FIG. 2 is a perspective view illustrating a basic configuration of a label printer.

FIG. 3 illustrates a configuration of the label printer according to a first example embodiment of the present invention.

FIG. 4 illustrates another configuration of the label printer according to the first example embodiment of the present invention.

FIGS. 5A and 5B illustrate the bending permissible space of a roll label according to an example embodiment of the present invention.

FIG. 6 illustrates how the bending direction of a sheet is controlled according to an example embodiment of the present invention.

FIG. 7 illustrates how the driving speed of each roller is controlled while a printing operation is performed, according to the first example embodiment of the present invention.

FIGS. 8A and 8B illustrate the operation sequences of a printing controller, a cutter conveyance controller, and a cutter controller between the start and end of a printing operation, in the label printer according to the first example embodiment of the present invention.

FIG. 9 illustrates the driving speed of each roller of an ink-jet printer that alternately performs a main scanning and a sub-scanning movement, according to a second example embodiment of the present invention.

FIG. 10 illustrates how the driving speed of each roller is controlled while a printing operation is performed, according to a third example embodiment of the present invention.

FIGS. 11A and 11B illustrate the operation sequences of a printing controller, a cutter conveyance controller, and a cutter controller between the start and end of a printing operation in the label printer according to the third example embodiment of the present invention.

FIG. 12 illustrates a configuration of the label printer according to a fourth example embodiment of the present invention.

FIG. 13 illustrates the driving speeds of a conveyance roller R2 and a cutter conveyance roller R3 when the first cutter cuts each page according to the speed control illustrated in FIG. 7.

FIG. 14 illustrates the driving speeds of a conveyance roller R2 and a cutter conveyance roller R3 when the first cutter cuts one page for every four pages.

The accompanying drawings are intended to depict exemplary embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

Example embodiments of the present invention will be described below in detail with reference to the drawings.

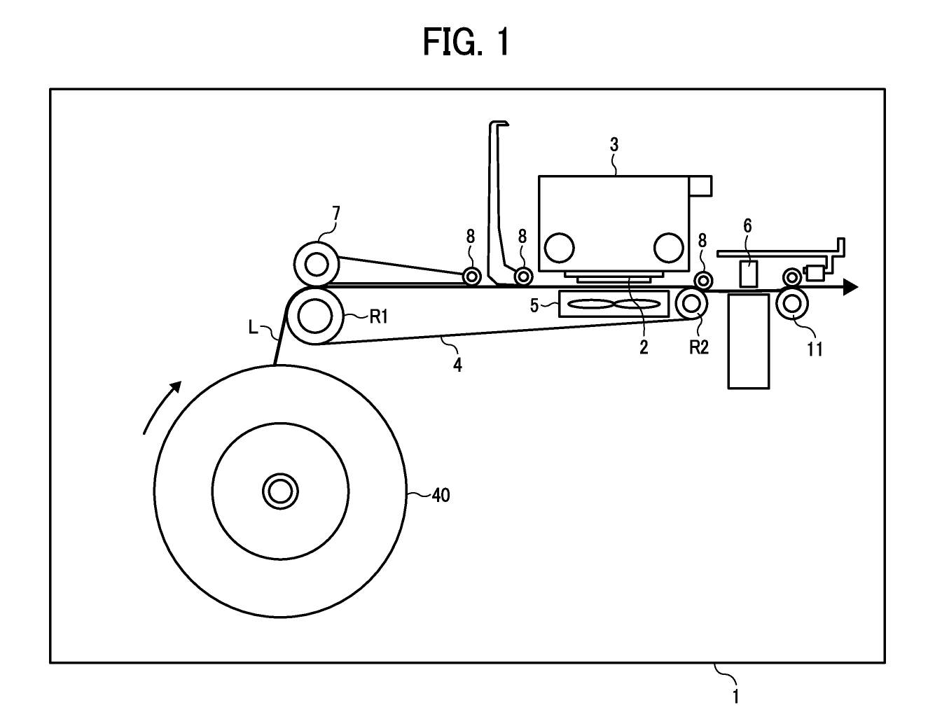

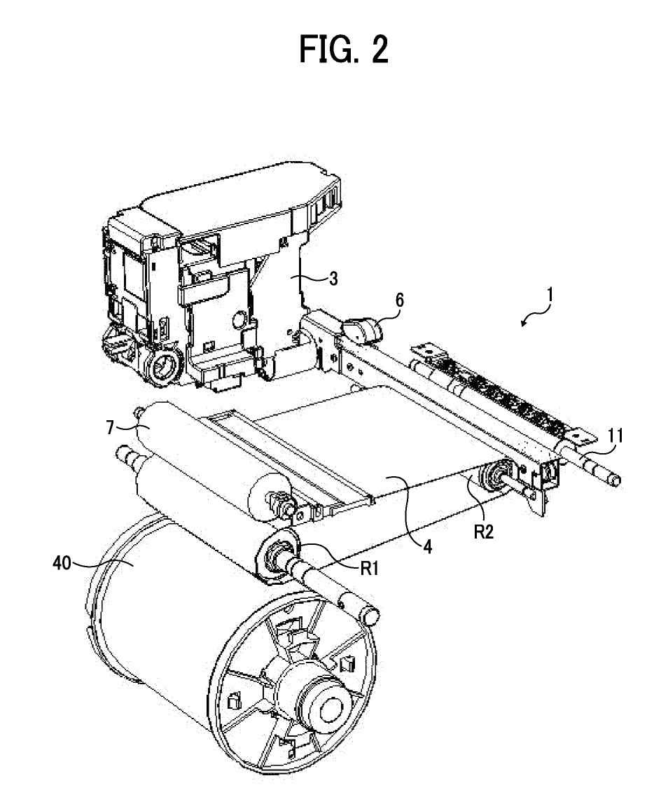

FIG. 1 is a schematic diagram illustrating a basic configuration of a label printer that serves as an image forming apparatus. FIG. 2 is a perspective view illustrating a basic configuration of the label printer of FIG. 1. For clarity, in FIG. 2, a main cabinet, structural elements, and stays are not illustrated.

A label printer 1 illustrated in FIG. 1 is an ink-jet printer that performs printing by ejecting ink on a linerless label that does not have a release paper (i.e., liner). The label printer 1 includes a rolled label sheet (i.e., roll label) 40, a print head 2 that ejects ink, and a carriage 3 provided with the print head 2 that moves in the main scanning direction as guided by a guide rail. Further, the label printer 1 includes a conveyance belt 4 that conveys label paper (print media) L fed from the roll label 40, a fan 5 that adsorbs a label on the conveyance belt 4 while the label is being conveyed, and a cutter 6 that cuts the label paper L on which printing has been performed. Note that the surface of the conveyance belt 4 is coated with an anti-adhesive so as not to become sticky due to the adhesive of the label paper L. A counter roller 7 and a pressure roller 8 press the label paper L against the conveyance belt 4, and conveyance force is given to the label paper L.

The label paper L fed from the roll label 40 is sent beneath the carriage 3 by the conveyance belt 4, which rotates as driven by a conveyance roller R1. The carriage 3 performs a printing operation by scanning the label paper L that has reached the area beneath the carriage 3, in the direction perpendicular to the conveyance direction. After the printing operation, the label paper L is sent to an area under the cutter 6, and the cutter 6 cuts the label paper L when the label paper L is at a specified length. The leading end of the label paper L on the downstream side of the cut position is ejected outside the main body, and the trailing end of the label paper L is stopped and held by an ejection roller 11. It is to be noted that the printing operation of the print head 2 may be performed by employing a line head system instead of a system such as that illustrated in FIG. 1.

### First Embodiment

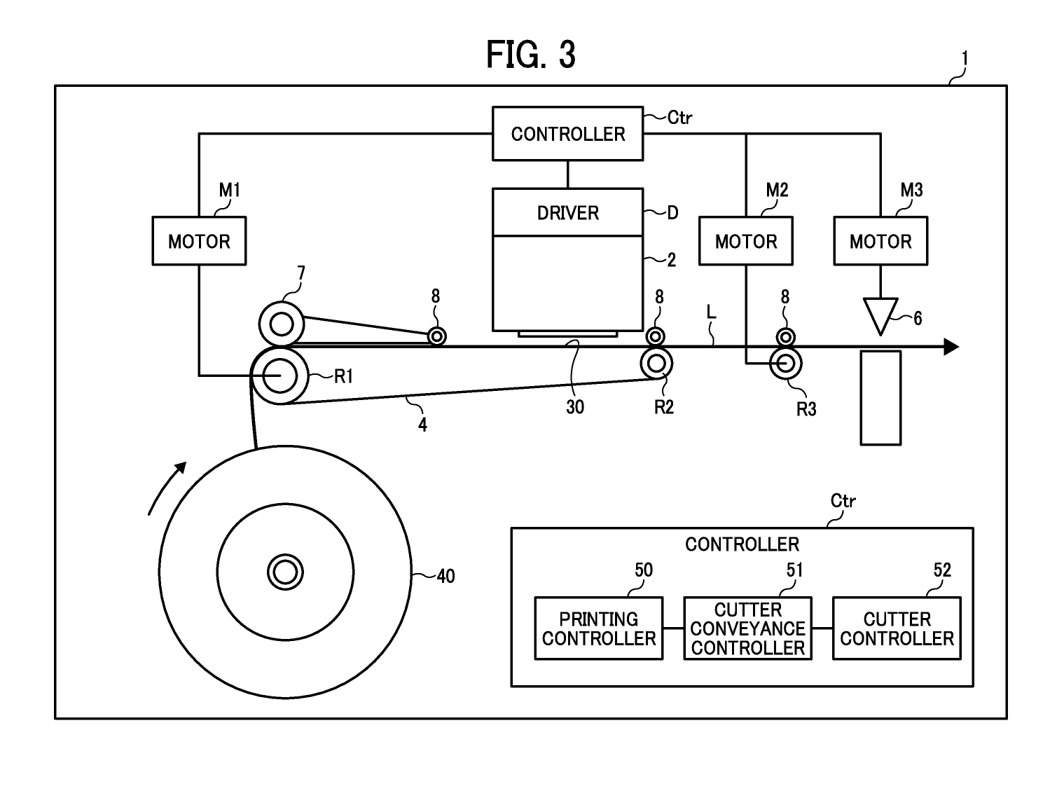

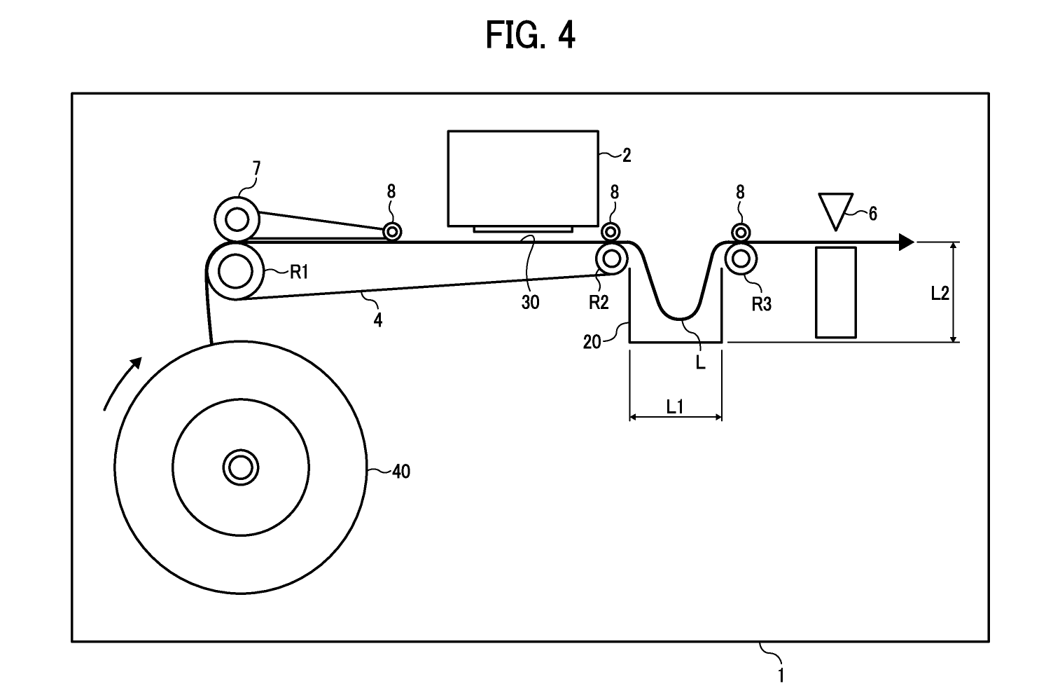

FIGS. 3 and 4 illustrate the configuration of a label printer according to a first embodiment. In addition to the basic configuration illustrated in FIGS. 1 and 2, an additional configuration is added before the cutter 6. In the description of FIGS. 3 and 4, the use of a line head system is assumed. Accordingly, an element such as a carriage, which is illustrated in FIGS. 1 and 2, is omitted. In FIGS. 3 and 4, the roll label 40 is conveyed by the conveyance belt 4 that is stretched by the conveyance roller R1 as a drive roller and a conveyance roller R2 as a driven roller, and a printing operation is performed at a print position 30 beneath the print head 2. The print head 2 is fixed as a line head, and ejects ink in a synchronized manner with the progression of a sheet. Alternatively, however, the print head 2 may be provided with a carriage that moves in the main scanning direction, as described with reference to FIGS. 1 and 2.

A cutter conveyance roller R3 (second roller) is arranged on the downstream side of the conveyance belt 4 (i.e., farther downstream of the conveyance roller R2). In other words, the cutter conveyance roller R3 is arranged near the cutter 6. The cutter conveyance roller R3 sends the label paper L to the cutter 6. Thus, the conveyance unit of the label printer 1 is composed of the conveyance roller R1, the conveyance roller R2 (first roller), the conveyance belt 4, and the cutter conveyance roller R3 (second roller). The sheet (label paper L) is a linerless paper, and thus its adhesive surface touches the conveyance belt 4. The label paper L moves towards the cutter 6 while the conveyance roller R1 is being driven, and the label paper L stops moving when the conveyance roller R1 stops. The conveyance roller R1 and the conveyance roller R2 (first roller) that is driven by the conveyance roller R1 are always driven while a printing operation is being performed.

As illustrated in FIG. 3, the label printer 1 includes motors M1, and M2, and M3 that drive the conveyance roller R1, the cutter conveyance roller R3, and the cutter 6, respectively. Moreover, the label printer 1 includes a driver D that drives a piezoelectric actuator provided for the print head 2. Alternatively, the conveyance roller R2 may be configured to be a drive roller that is driven by the motor M1, and the conveyance roller R1 may be a driven roller in the driving mechanism of the conveyance belt 4. Moreover, the label printer 1 includes a controller Ctr that mainly controls the conveying and printing operation of the label paper L. The controller Ctr includes a printing controller 50, a cutter conveyance controller 51, and a cutter controller 52.

The printing controller 50 controls the motor M1 and the driver D1 to control the printing operation. The cutter conveyance controller 51 controls the motor M2 to bend a label between the conveyance roller R2 and the cutter conveyance roller R3. The cutter controller 52 controls the motor M3 to operate the cutter 6. The controller Ctr includes a CPU (central processing unit), a ROM (read only memory), and a RAM (random access memory), and implements the printing controller 50, the cutter conveyance controller 51, and the cutter controller 52 by reading and executing software in the CPU.

The cutter conveyance roller R3 is driven when a printing operation is progressing, but the cutter conveyance roller R3 stops when a cutting operation is being performed. By contrast, the conveyance roller R1 (and the conveyance belt 4) keeps moving, and thus a sheet is bent in bending permissible space 20 arranged between the conveyance roller R2 and the cutter conveyance roller R3, as illustrated in FIG. 4. FIG. 4 illustrates a state in which the label paper L is bent in the configuration of FIG. 3, where the label paper L is bent between the conveyance roller R2 and the cutter conveyance roller R3. Because the label paper L may stick to other members, the bending permissible space 20 of the label printer 1 where bending is permissible is determined by the layout of the printer 1. In FIG. 4, the horizontal and vertical dimensions of the bending permissible space 20 are L₁ and L₂, respectively.

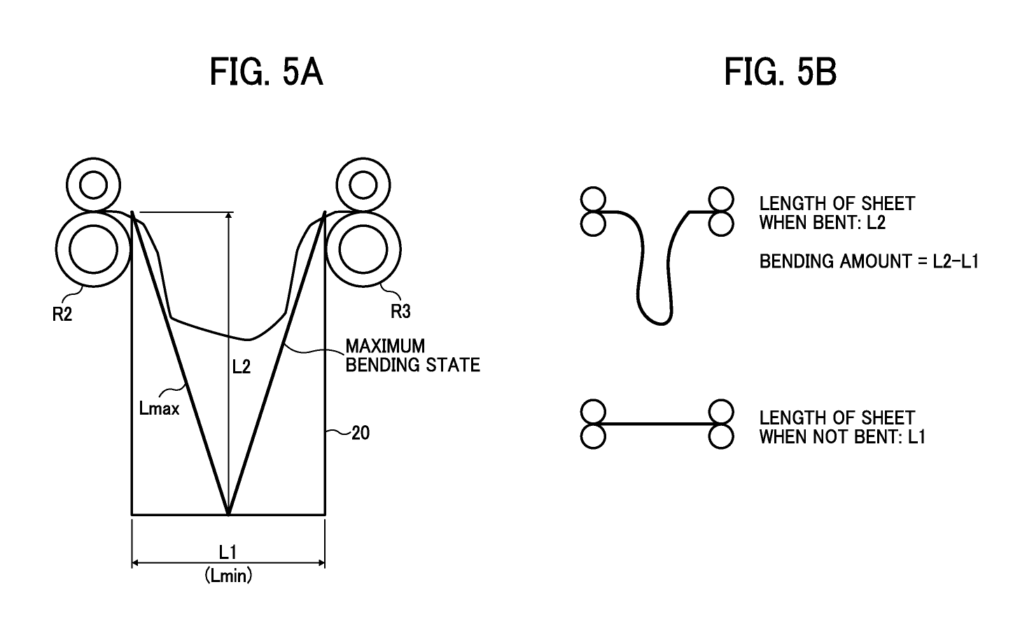

FIGS. 5A and 5B illustrate the bending permissible space 20 of the roll label 40. As illustrated in FIG. 5A, the horizontal and vertical dimensions of the bending permissible space 20 are defined by L₁ and L₂, respectively, and the maximum length of a sheet permissible in the bending permissible space 20 is assumed to be Lₘₐₓ. The minimum length of sheet Lₘᵢₙ becomes equivalent to L₁ when no bending is present, that is, when the sheet is stretched between rollers R2 and R3. Accordingly, the maximum permissible bending amount M is calculated by Formula 1 below.

M=Lₘₐₓ−Lₘᵢₙ=\sqrt{L₁²+(2L₂)²}−L₁ [Formula 1]

Here, the bending amount refers to the length of a sheet that is placed in the bending permissible space 20. As illustrated in FIG. 5B, assuming that the length of a sheet when the sheet is bent is L₂ and the length of a sheet becomes equivalent to L₁ when the sheet is not bent, the bending amount is expressed as “L₂−L₁”. The maximum permissible bending amount is a threshold that is defined by a person who designed the product, and indicates the maximum value for permissible bending amount (i.e., the smallest value beyond which leads to conveyance failure).

Excessive bending can be prevented by controlling the difference in linear velocity (i.e., difference in rotation speed) between the conveyance roller R2 and the cutter conveyance roller R3 to meet the following equation.

V_{diff}*T_{cut}≦Lₘₐₓ

Here, V_{diff}, T_{cut}, and Lₘₐₓ indicate a difference in the linear velocity of rollers, the length of time during which a cut operation is performed, and the maximum length of a sheet permissible in bending permissible space, respectively.

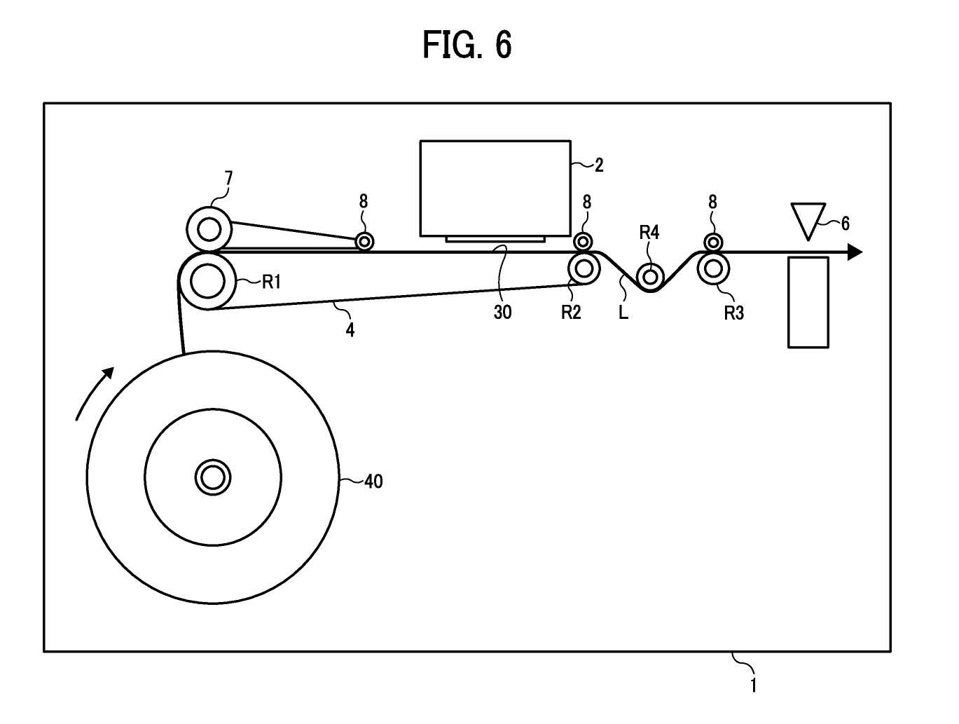

FIG. 6 illustrates how the bending direction of a sheet is controlled according to an example embodiment of the present invention. There are some cases in which bending is not easily achieved due to the inherent stiffness of some kinds of label paper L and consequently the label paper L bends upward. FIG. 6 illustrates how the direction in which the label paper L is bent is controlled to the downward direction. More specifically, a bending-direction controlling roller R4 is provided to bend a sheet downward (control the bending direction of a sheet) between the conveyance roller R2 and the cutter conveyance roller R3. The bending-direction controlling roller R4 bends the label paper L downward by using its own weight or downward spring-load. It is desired that the bending-direction controlling roller R4 be fixed to the upper side of the sheet conveyance path when it is not used.

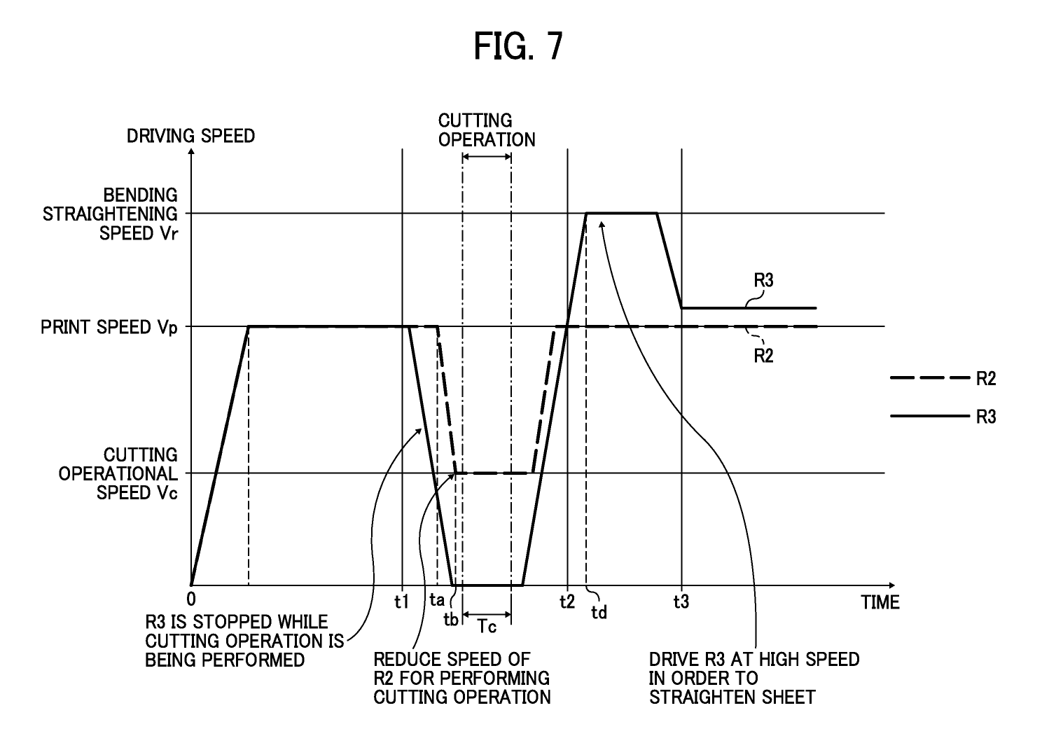

FIG. 7 illustrates how the driving speed of each roller is controlled while a printing operation is performed, according to an example embodiment of the present invention. As illustrated in FIG. 7, the controller Ctr controls the driving speed of the conveyance roller R2 and the cutter conveyance roller R3 as follows. The conveyance roller R2 may be directly driven, or may be indirectly driven via the conveyance belt 4. Once a printing operation starts, the printing controller 50 and the cutter conveyance controller 51 start driving the conveyance roller R2 and the cutter conveyance roller R3, and increase the driving speed of both the conveyance roller R2 and the cutter conveyance roller R3 to print speed Vₚ. Next, the cutter conveyance controller 51 starts reducing the speed of the cutter conveyance roller R3 at time t1 in order to stop a sheet at the position where a cutting operation is performed. Then, the cutter conveyance controller 51 stops the cutter conveyance roller R3 at time tb.

The printing controller 50 starts reducing the speed of the conveyance roller R2 at time ta, which is later than time t1, and reduces the speed to cutting operational speed V_{c} at time tb. The bending amount of the label paper L is controlled to be equal to or less than a threshold amount when the cutting operational speed V_{c} is employed. The speed of the conveyance roller R2 is reduced at time ta, which is later than when the speed of the cutter conveyance roller R3 is reduced at time t1, because a sheet stretches if the speed of the conveyance roller R2 is reduced before the speed of the cutter conveyance roller R3 is reduced. When the cutter conveyance roller R3 stops moving and the conveyance roller R2 reaches the cutting operational speed V_{c} at time tb, the cutter controller 52 instructs the cutter 6 to perform a cutting operation before time Tc passes. The cutter conveyance roller R3 stops moving during the period of time Tc. When the cutting operation is complete, the printing controller 50 returns the speed of the conveyance roller R2 to the print speed Vₚ.

Then, the cutter conveyance controller 51 returns the speed of the cutter conveyance roller R3 to the print speed Vₚ by time t2, and increases the speed of the cutter conveyance roller R3 to a bending straightening speed Vᵣ that is faster than the print speed Vₚ by time td in order to straighten a sheet. After time t2, bending is straightened by the amount of the product of elapsed time and the difference in speed between the conveyance roller R2 and the cutter conveyance roller R3. When the bending accumulated during the cutting operation is all straightened after time td, the cutter conveyance controller 51 returns the speed of the cutter conveyance roller R3 to the print speed Vₚ by time t3.

The print speed Vₚ, the cutting operational speed V_{c}, and the bending straightening speed Vᵣ are described in detail below.

The print speed Vₚ indicates the conveyance speed of a sheet when normal printing operation is performed, and is the regular printing speed of a printer as designed. The cutting operational speed V_{c} indicates the conveyance speed of the conveyance roller R2 while a cutting operation is in progress. The cutting operational speed V_{c} should be such that the bending occurred during the time between t1 and t2 will be equal to or less than the maximum permissible bending amount M, calculated in Formula 1 as described above.

More specifically, the bending amount of a sheet caused in a cutting operation is the accumulated value of the difference in speed between time t1 at which the cutter conveyance roller R3 starts reducing speed and time t2 at which the speed of the cutter conveyance roller R3 is increased after the cutting operation and exceeds the print speed Vₚ. As the acceleration and deceleration curves or the like of the conveyance roller R2 and the cutter conveyance roller R3 are designed in advance, the cutting operational speed V_{c} is calculated by using Formula 2 below.

∫ₜ₁^{t2}(V₂(t)−V₃(t))dt≦M [Formula 2]

Here, speed V2(t), V3(t), and M indicate the speed of the conveyance roller R2 at time t, the speed of the cutter conveyance roller R3 at time t, and the maximum permissible bending amount, respectively.

Alternatively, the cutting operational speed V_{c} may be approximated from Formula 3 below, ignoring the acceleration and deceleration curve.

V_{c}*T_{c}≦M [Formula 3]

The bending straightening speed Vᵣ indicates the conveyance speed of the cutter conveyance roller R3 when the bending portion of a sheet is to be straightened after the cutting operation. As the accumulated value of the difference in speed between the conveyance roller R2 and the cutter conveyance roller R3 during the time between times t2 and t3 is the amount of bending to be straightened, the bending straightening speed Vᵣ can be calculated by Formula 4 as follows.

∫ₜ₁^{t2}(V₂(t)−V₃₍ₜ₎)dt =∫ₜ₂^{t3}(V₃₍ₜ₎−V₂₍ₜ₎)dt [Formula 4]

Alternatively, the bending straightening speed Vᵣ may be approximated from Formula 5 below, ignoring the acceleration and deceleration curve.

V_{c}*T_{c}=Vᵣ*(t3−t2)

As described above, the conveyance roller R2 is not stopped even when a cutting operation is being performed by the cutter 6. Accordingly, the printing operation (e.g., image forming process and sheet conveying process) does not stop while a cutting operation is in progress.

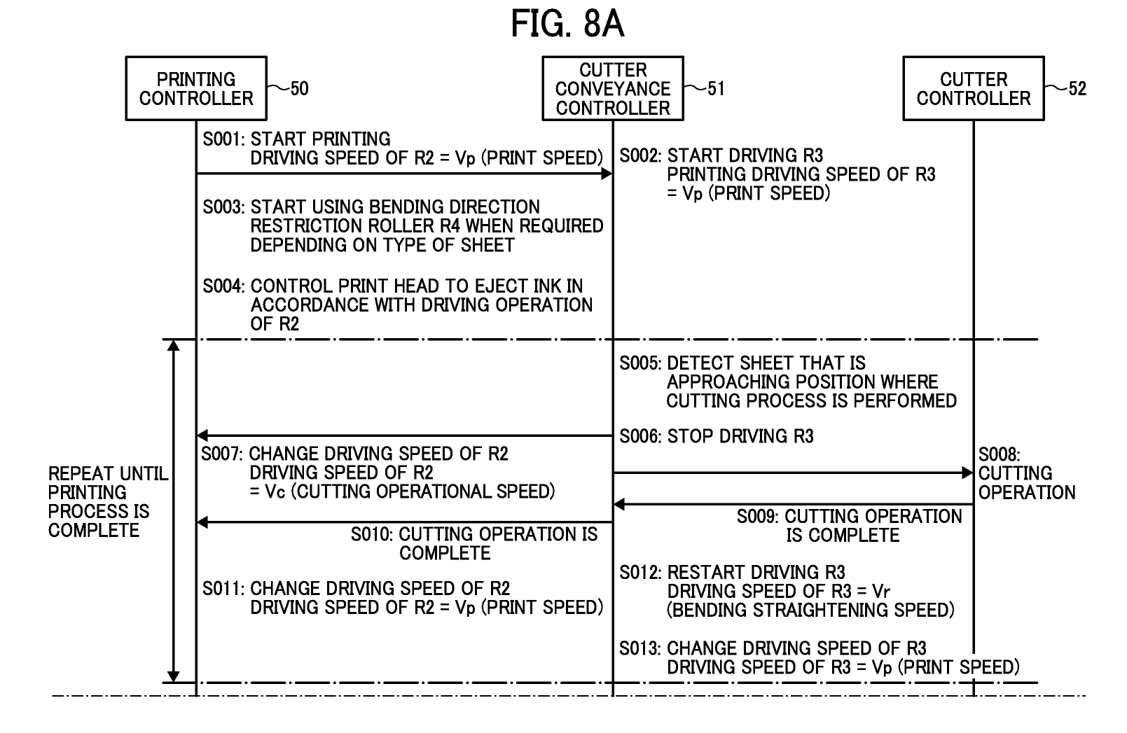

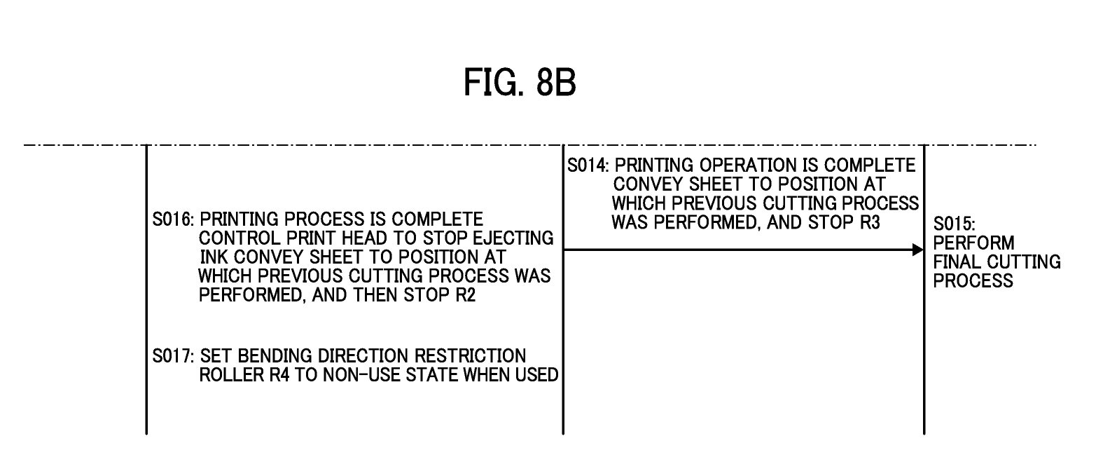

FIGS. 8A and 8B illustrate the operation sequences of the printing controller 50, the cutter conveyance controller 51, and the cutter controller 52 between the start and end of a printing operation in the label printer 1, according to the first embodiment. As described above, the printing controller 50 controls the ejecting process at the print head 2, the driving process of the conveyance roller R2, and the controlling process of the bending-direction controlling roller R4. The cutter conveyance controller 51 controls the driving process of the cutter conveyance roller R3. The cutter controller 52 controls the operation of the cutter 6.

(1) The printing controller 50 initiates a printing process, and increases the speed of the conveyance roller R2 to the print speed Vₚ (S001). The printing controller 50 instructs the cutter conveyance controller 51 to start a printing process, and the cutter conveyance controller 51 increases the driving speed of the cutter conveyance roller R3 to print speed Vₚ (S002).

(2) When the type of a sheet (label paper L) is a specified type of sheet that requires the use of the bending-direction controlling roller R4, the printing controller 50 initiates the operation of the bending-direction controlling roller R4 (S003). Next, the printing controller 50 controls the print head 2 to eject ink on a sheet (S004).

(3) The cutter conveyance controller 51 monitors the position of a sheet, and detects a sheet that is approaching the position where a cutting process is performed (S005). The cutter conveyance controller 51 provides the printing controller 50 with notification that a cutting operation will be performed, while stopping the cutter conveyance roller R3 (S006).

(4) When such a cutting operation notification is received, the printing controller 50 decreases the speed of the conveyance roller R2 to the cutting operational speed V_{c} (S007).

(5) When the cutter conveyance roller R3 is stopped, the cutter conveyance controller 51 instructs the cutter controller 52 to perform a cutting operation, and the cutter controller 52 performs the cutting operation as instructed (S008).

(6) When the cutting operation is complete, the cutter controller 52 provides the cutter conveyance controller 51 and the printing controller 50 with notification that the cutting operation is complete (S009 and S010).

(7) When the notification is received, the printing controller 50 increases the speed of the conveyance roller R2 to the print speed Vₚ (S011). The cutter conveyance controller 51 increases the speed of the cutter conveyance roller R3 to the bending straightening speed Vᵣ (S012). Because the bending straightening speed Vᵣ is faster than the print speed Vₚ, the amount of bending accumulated due to the cutting operation is straightened. When the bending is straightened, the cutter conveyance controller 51 returns the speed of the cutter conveyance roller R3 to the print speed Vₚ (S013).

(8) Every time a cutting process is performed, the steps (3) to (7) are repeated.

(9) When the printing operation is complete, the cutter conveyance controller 51 conveys a sheet to the position at which the previous cutting process was performed, and stops the cutter conveyance roller R3 (S014). Subsequently, the cutter conveyance controller 51 instructs the cutter controller 52 to perform a cutting process, and the cutter controller 52 performs a final cutting process (S015).

(10) When the printing process is complete, the printing controller 50 conveys a sheet to the position at which the previous cutting process was performed and then stops the conveyance roller R2 (S016). When the bending-direction controlling roller R4 was used in the cutting process, the bending-direction controlling roller R4 is set to a non-use state (S017).

### Second Embodiment

In the second embodiment, the speed of the conveyance roller R2 and the cutter conveyance roller R3 of FIG. 7 is controlled, and it is assumed that a printer employs a line head system or the like. Alternatively, however, a configuration that is employed in various ink-jet printers, where a main scanning and a sub-scanning are alternately performed, may be employed.

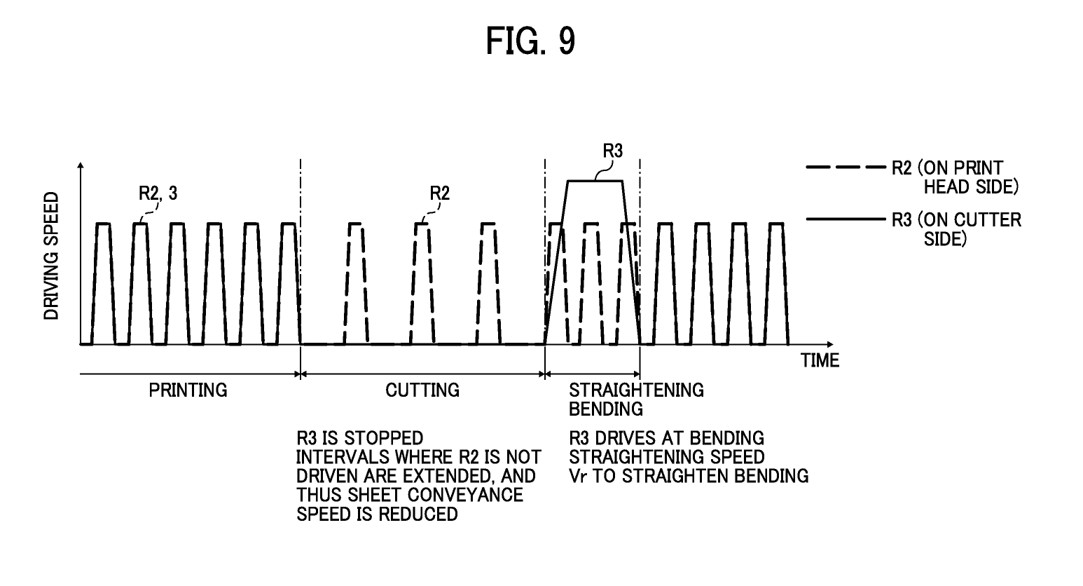

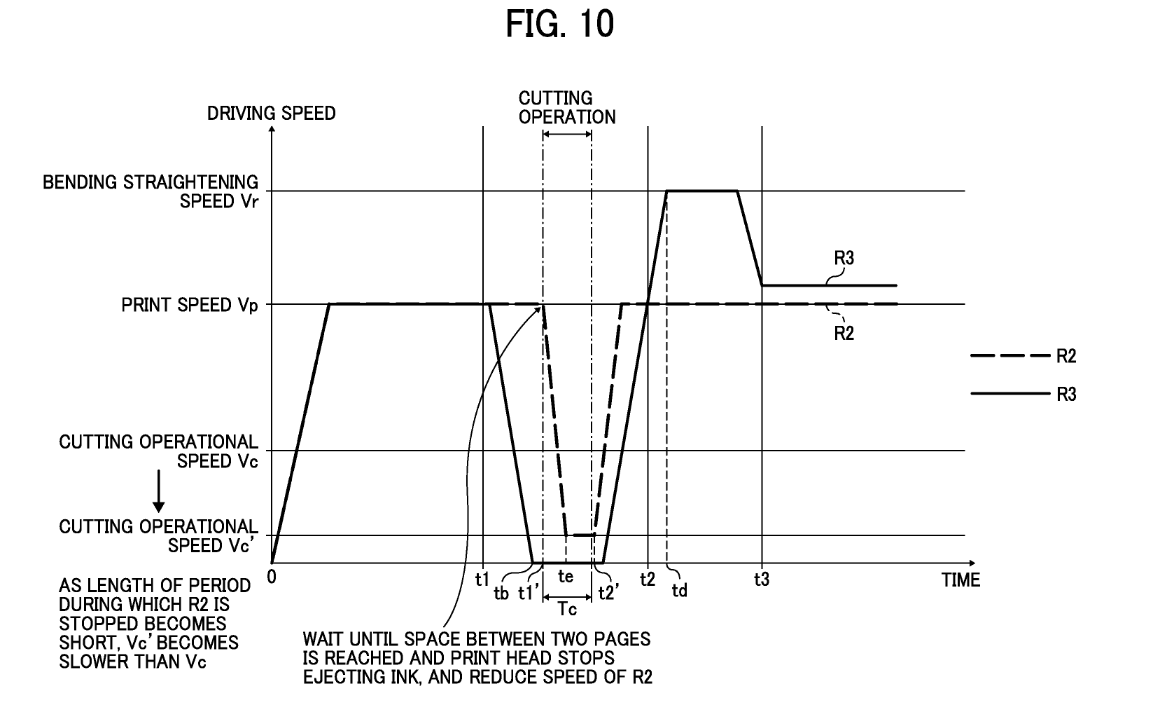

FIG. 9 illustrates the driving speed of the conveyance roller R2 and the cutter conveyance roller R3 of an ink-jet printer that alternately performs a main scanning and a sub-scanning movement, according to the second embodiment. In FIG. 7, the conveyance roller R2 and the cutter conveyance roller R3 operate at the print speed Vₚ, which is slow. By contrast, a sheet is not conveyed while a main scanning is being performed in the configuration of FIG. 9, and thus the conveyance roller R2 and the cutter conveyance roller R3 stop moving while a main scanning is being performed. While a sub-scanning is being performed, the conveyance roller R2 and the cutter conveyance roller R3 operate to convey a sheet in a similar manner to each other. In FIG. 7, the speed of the conveyance roller R2 is reduced to the cutting operational speed V_{c} while a cutting operation is being performed. By contrast, intervals where the conveyance roller R2 is not driven are extended in the configuration of FIG. 9. Because the cutter conveyance roller R3 does not operate while a cutting operation is being performed, bending occurs during the cutting operation.

In the configuration of FIG. 9, the number of times a sub-scanning is performed during the cutting operation is restricted to satisfy Formula 6. The intervals where the conveyance roller R2 is not driven are increased to satisfy Formula 6.

(Number of times sub-scanning is performed)*(Amount of sheet conveyance due to sub-scanning)≦M (Maximum permissible bending amount) [Formula 6]

After the cutting operation, a bending straightening operation is performed. In this configuration, the driving speed of the cutter conveyance roller R3 and the period during which the cutter conveyance roller R3 is driven are controlled to satisfy Formula 7 below.

(Number of times sub-scanning (R2) is performed during cutting operation and bending straightening operation)*(Amount of sheet conveyance due to sub-scanning)=(Amount of sheet conveyance due to operation of cutter conveyance roller R3 during bending straightening operation) [Formula 7]

The process returns to (1) (i.e., S001 and S002) after the bending straightening operation is completed, and the conveyance roller R2 and the cutter conveyance roller R3 operate to convey a sheet in a similar manner to each other.

### Third Embodiment

In the first embodiment, after the speed of the conveyance roller R2 is reduced for a cutting operation, the speed of the cutter conveyance roller R3 is immediately or shortly reduced to the cutting operational speed V_{c}. However, when the printing quality of a printer with a line head system is affected (e.g., streaks appear) due to a change in the conveyance speed, the acceleration and deceleration of the conveyance roller R2 may be performed during a period where no printing is performed in the interval between two pages. The length of time it takes to reach the interval between two pages after a sheet (i.e., label paper L) has reached a cutting position and the cutter conveyance roller R3 has stopped varies every time depending on the page length or the like, and thus it is necessary to calculate a value for cutting operational speed V_{c}′ when the cutter conveyance roller R3 stops. The cutting operational speed V_{c}′ is approximated by Formula 8 below.

(t1′−t1)*Vₚ+(t2′−t1′)*V_{c}′≦M [Formula 8]

t1′: time at which the speed of the conveyance roller R2 is reduced

t2′: time at which cutting operation is complete and the speed of the conveyance roller R2 is increased

When the cutting operational speed V_{c}′ calculated by Formula 8 has a negative value, the printing operation is stopped or the conveyance roller R2 is stopped as the cutter conveyance roller R3 is stopped as in FIG. 9 without waiting in the interval between two pages.

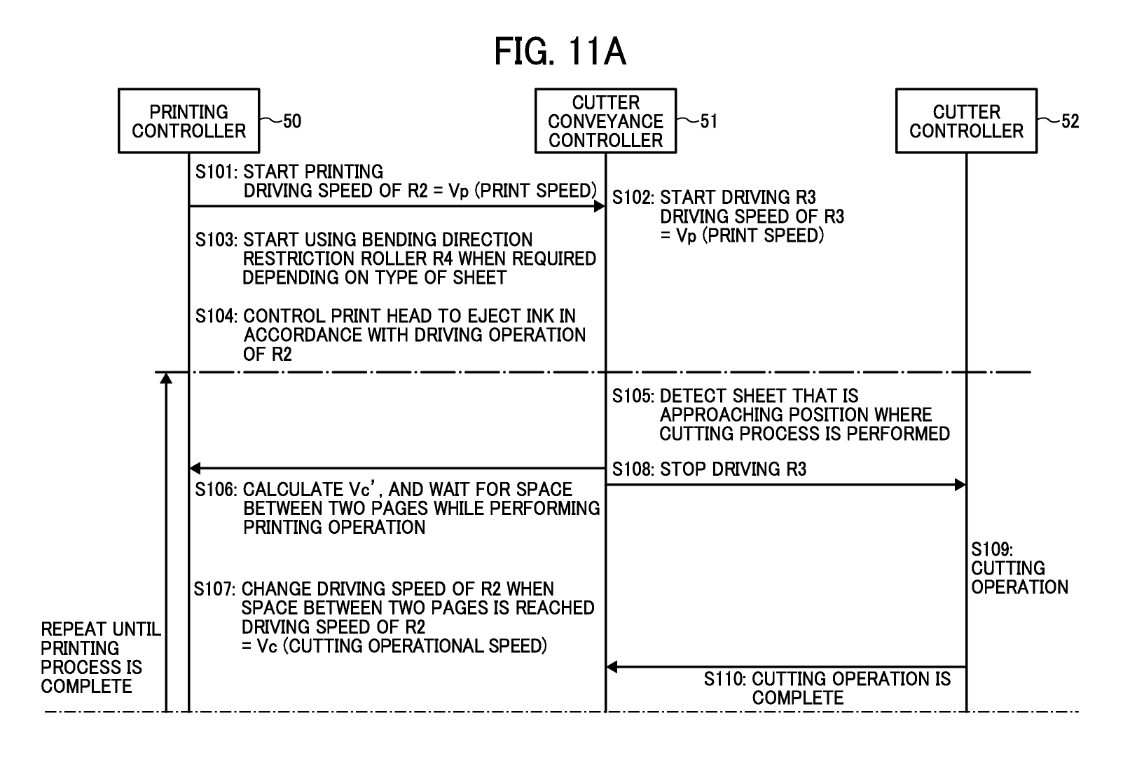

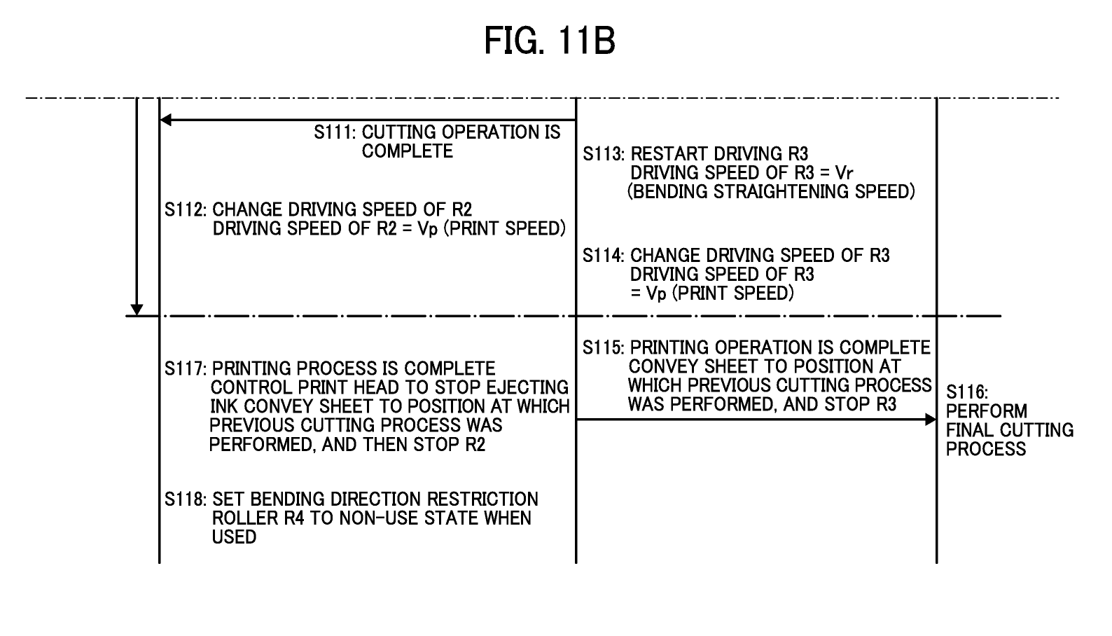

FIGS. 11A and 11B illustrate the operation sequences of each controlling element in the label printer 1, according to the third embodiment. In the operation sequences of FIGS. 11A and 11B, the following steps are performed.

(1) The printing controller 50 initiates a printing process, and increases the speed of the conveyance roller R2 to the print speed Vₚ (S101). The printing controller 50 instructs the cutter conveyance controller 51 to start a printing process, and the cutter conveyance controller 51 increases the driving speed of the cutter conveyance roller R3 to the print speed Vₚ (S102).

(2) When the type of a sheet (label paper L) is a specified type of sheet that requires the use of the bending-direction controlling roller R4, the printing controller 50 initiates the operation of the bending-direction controlling roller R4 (S103). Next, the printing controller 50 controls the print head 2 to eject ink on a sheet (S104).

(3) The cutter conveyance controller 51 monitors the position of a sheet, and detects a sheet that is approaching the position where a cutting process is performed (S105). The cutter conveyance controller 51 calculates cutting operational speed V_{c}′ by using Formula 8 as above, and waits in the interval between two pages while performing a printing operation (S106).

(4) When the interval between two pages is reached, the printing controller 50 decreases the speed of the conveyance roller R2 to the cutting operational speed V_{c}′ (S107). The cutter conveyance controller 51 provides the printing controller 50 with notification that a cutting operation will be performed, while stopping the cutter conveyance roller R3 (S108).

(5) When the cutter conveyance roller R3 is stopped, the cutter conveyance controller 51 instructs the cutter controller 52 to perform a cutting operation, and the cutter controller 52 performs the cutting operation as instructed (S109).

(6) When the cutting operation is complete, the cutter controller 52 provides the cutter conveyance controller 51 and the printing controller 50 with notification that the cutting operation is complete (S110 and S111).

(7) When the notification is received, the printing controller 50 increases the speed of the conveyance roller R2 to the print speed Vₚ (S112). The cutter conveyance controller 51 increases the speed of the cutter conveyance roller R3 to the bending straightening speed Vᵣ (S113). Because the bending straightening speed Vᵣ is faster than the print speed Vₚ, the amount of bending accumulated due to the cutting operation is straightened. When the bending is straightened, the cutter conveyance controller 51 returns the speed of the cutter conveyance roller R3 to the print speed Vₚ (S114).

(8) Every time a cutting process is performed, the steps (3) to (7) are repeated.

(9) When the printing operation is complete, the cutter conveyance controller 51 conveys a sheet to the position at which the previous cutting process was performed, and stops the cutter conveyance roller R3 (S115). Subsequently, the cutter conveyance controller 51 instructs the cutter controller 52 to perform a cutting process, and the cutter controller 52 performs a final cutting process (S116).

(10) When the printing process is complete, the printing controller 50 conveys a sheet to the position at which the previous cutting process was performed and then stops the conveyance roller R2 (S117). When the bending-direction controlling roller R4 was used in the cutting process, the bending-direction controlling roller R4 is set to a non-use state (S118).

### Fourth Embodiment

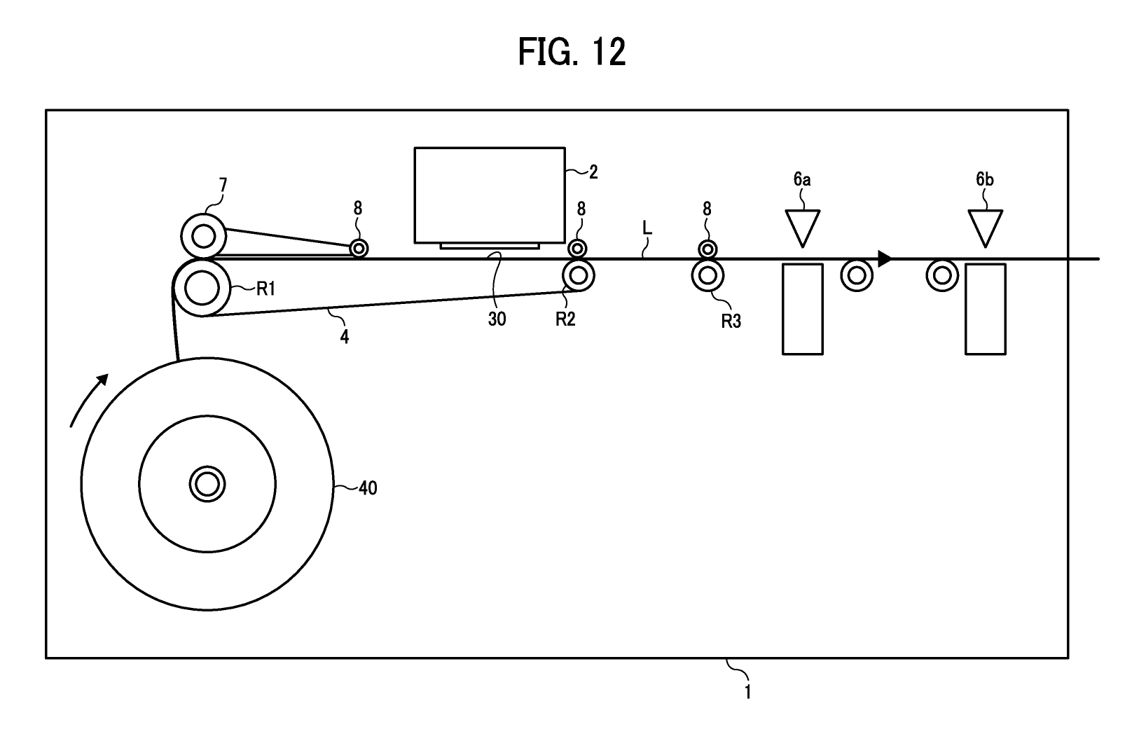

FIG. 12 illustrates a configuration of the label printer according to the fourth embodiment. If all the pages are cut by a single cutter in the cutting operation referred to in FIG. 7, the conveyance roller R2 and the cutter conveyance roller R3 are constantly accelerated and decelerated. This leads to low productivity. In order to address this problem, productivity may be improved by providing two cutters (i.e., first cutter 6a and second cutter 6b), as illustrated in FIG. 12. The first cutter 6a on the upstream side of the conveyance direction cuts one sheet for every certain number of sheets and the second cutter 6b on the downstream side of the conveyance direction cuts the rest of the sheets.

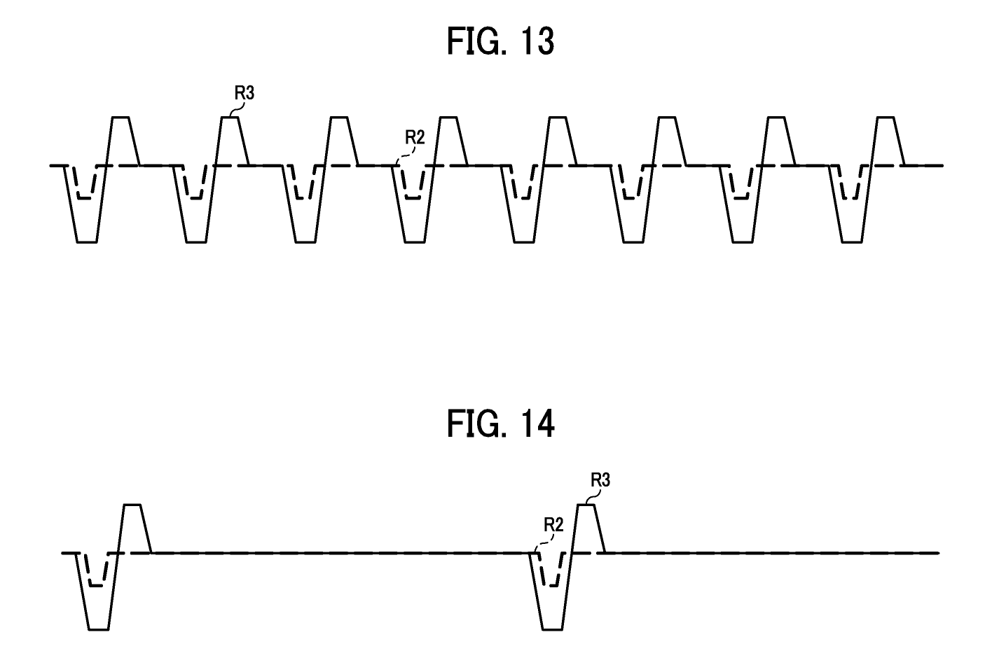

FIG. 13 illustrates the driving speeds of the conveyance roller R2 and the cutter conveyance roller R3 when the first cutter 6a cuts each page according to the speed control illustrated in FIG. 7. FIG. 14 illustrates the driving speeds of the conveyance roller R2 and the cutter conveyance roller R3 when the first cutter 6a cuts one page for every four pages. In the case of FIG. 14, the number of times the speed of the conveyance roller R2 is reduced is decreased compared with the case of FIG. 13, and the printing speed improves accordingly. After sheets have passed the first cutter 6a, these sheets are no longer influenced by the printing operation. Thus, the sheets can be conveyed at high speed between the first cutter 6a and the second cutter 6b, and the second cutter 6b cuts the rest of the pages.

### Fifth Embodiment

In the first embodiment, the state of maximum bending as illustrated in FIG. 5 is assumed, and the maximum permissible bending amount is calculated by using Formula 1. However, a margin may be provided as in Formula 1′ below.

M=Lₘₐₓ−Lₘᵢₙ=\sqrt{L₁²+(2L₂)²}−L₁−m [Formula 1′]

Here, “m” indicates a margin. Alternatively, a threshold may be calculated by performing an examination with an actual device, instead of using the assumption of FIG. 5.

According to the configuration described above, efficient sheet conveyance and high-speed printing are achieved in an image forming apparatus that is provided with a cutter on the downstream side of a print head.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

What is claimed is:

1. An image forming apparatus comprising:
a conveyer belt configured to convey print media;
a print head configured to print an image on the print media conveyed by the conveyer belt;
a cutter disposed downstream of the print head and configured to cut the print media;
at least first and second rollers serially arranged between the print head and the cutter and configured to rotate the conveyer belt in the conveyance direction to convey the print media toward the cutter; and
a controller configured to individually control rotation speeds of the rollers to create a difference in rotation speed between the first and second rollers sufficient to make the print media bend between the first and second rollers while the cutter cuts.

2. The image forming apparatus according to claim 1, wherein the first roller and the second roller are arranged on the print head side and on the cutter side, respectively, and the controller stops the second roller while the cutter cuts.

3. The image forming apparatus according to claim 2, wherein the controller controls the difference in rotation speed sufficient to keep bending of the print media below a specified maximum permissible amount.

4. The image forming apparatus according to claim 3, wherein
the maximum permissible bending amount of the print media denoted by M satisfies the condition
∫ₜ₁^{t2}(V₂(t)−V₃(t))dt≦M
where the rotation speed of the first roller and the rotation speed of the second roller at time t during cutting by the cutter are V₂(t) and V₃(t), respectively, and
a cutting operation is performed between time t1 and time t2.

5. The image forming apparatus according to claim 3, wherein
the maximum permissible bending amount denoted by M is
M=\sqrt{L₁²+(2L₂)²}−L₁,
where length in conveyance direction and length in height direction are L₁ and L₂, respectively, in bending permissible space enclosing the bent print media.

6. The image forming apparatus according to claim 2, further comprising a third roller provided between the first and second rollers in the conveyance route to the cutter to control bending direction of the print media.

7. The image forming apparatus according to claim 2, wherein the controller controls rotation speed of the second roller to be faster than rotation speed of the first roller after cutting by the cutter, to straighten a bent portion of the print media.

8. The image forming apparatus according to claim 2, wherein the controller controls rotation speed of the first roller when printing is not performed by the print head.

9. The image forming apparatus according to claim 2, wherein
the cutter comprises a plurality of cutters, and
the controller controls the cutters to cut the print media in alternating sequence.

10. An image forming method comprising:
conveying, on a conveyer belt rotated by at least first and second rollers, print media on which an image is formed by a print head;
cutting the print media with a cutter positioned downstream of the print head; and
controlling speed of the conveying, by individually controlling rotation speeds of the rollers to create a difference in rotation speed between the first and second rollers sufficient to make the print media bend between the first and second rollers while the cutting is being performed.

11. The image forming method according to claim 10, wherein the controlling controls the difference in rotation speed sufficient to keep bending of the print media below a specified maximum permissible amount.
